(19) United States
(12) Patent Application Publication
(10) Pub. No.: US 2023/0041789 A1
(43) Pub. Date: Feb. 9, 2023

(54) GEOLOCATION BASED AUTOMATIC FILTRATION OF MEMBERS OF ONLINE SOCIAL GROUPS

(71) Applicant: Bishwadeep Bhattacharyya, Hillsboro, OR (US)

(72) Inventor: Bishwadeep Bhattacharyya, Hillsboro, OR (US)

(21) Appl. No.: 17/969,542

(22) Filed: Oct. 19, 2022

(51) Int. Cl. G06Q 50/00

(52) U.S. Cl. CPC G06Q 50/01

(57) ABSTRACT

Examples are directed to a manner in which users are admitted and/or removed from online social groups. In an example, a computer implemented method includes registering a plurality of users for an application associated with a plurality of online social groups, each online social group having corresponding criteria and a location based filter to join the group. The method further includes maintaining one or more tags of each user, and maintaining and tracking a location parameter of each user. The method further includes matching a first user to a first online social group, based on one or more corresponding tags and the location parameter of the first user satisfying the one or more criteria and the location based filter, respectively, of the first online social group. Based on matching the first user to the first online social group, the first user is admitted to the first online social group.

### FIELD OF THE DISCLOSURE

The present disclosure relates to online social groups, and more particularly, to a process of entering and/or exiting such online social groups.

### BACKGROUND

Online social groups have gained immense popularity in the last few years. Web sites and computer applications provide online social groups focusing on common interests or themes, and allow users to join online social groups or communities. For example, a neighborhood group may include people of a specific neighborhood, and a college alumni group may include alumni of the college. In an example, a group that includes people from a same neighborhood, or people from a same city, may allow in-person interaction between the group members.

### BRIEF DESCRIPTION OF THE DRAWINGS

So that the manner in which the described features of particular embodiments can be understood in detail, a more particular description of particular embodiments, may be had by reference to embodiments, some of which are illustrated in the appended drawings. It is to be noted, however, that the appended drawings illustrate only particular embodiments and are therefore not to be considered limiting of its scope, for the disclosure may admit to other equally effective embodiments.

FIG. 1 schematically illustrates a system environment for automatic filtration of users for joining and/or exiting various online social groups, e.g., based on one or more tags associated with individual users and based on a geolocation parameter that is updated dynamically for individual users, in accordance with an embodiment of the present disclosure.

FIG. 2 schematically illustrates a system architecture of the social networking application of FIG. 1, for facilitating automatic filtration of users for joining and/or exiting various online social groups, e.g., based on one or more tags associated with individual users and based on a geolocation parameter that is updated dynamically for individual users, in accordance with an embodiment of the present disclosure.

FIG. 3 illustrates a method for facilitating automatic filtration of users for joining and/or exiting various online social groups, e.g., based on one or more tags associated with individual users and based on a geolocation parameter that is updated dynamically for individual users, in accordance with an embodiment of the present disclosure.

### DETAILED DESCRIPTION

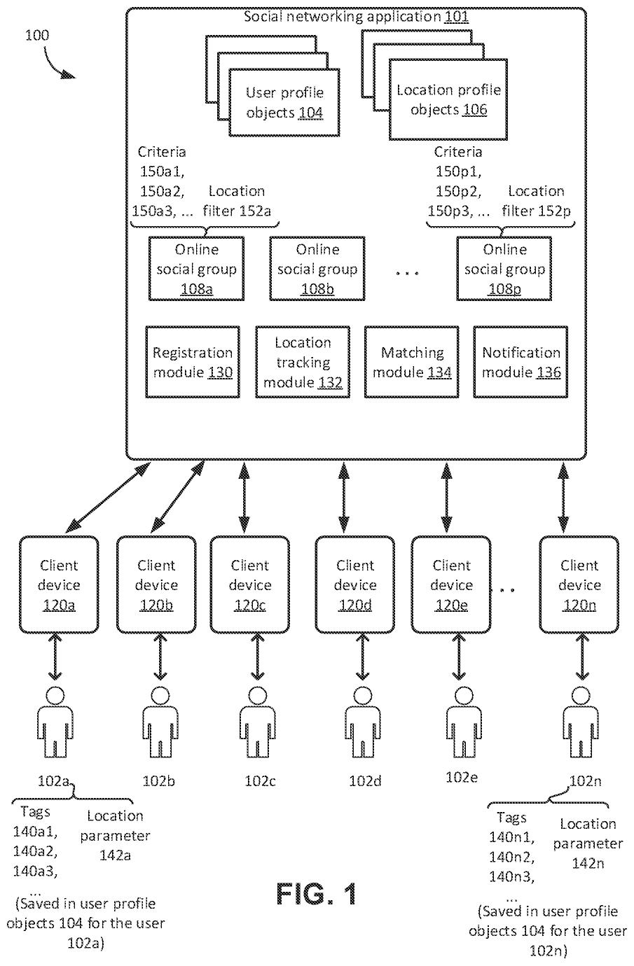

FIG. 1 schematically illustrates a system environment 100 for automatic filtration of users 102a, 102b, . . . , 102n for joining and/or exiting various online social groups 108a, . . . , 108p, e.g., based on one or more tags associated with individual users 102 and based on a geolocation parameter that is updated dynamically for individual users 102, in accordance with an embodiment of the present disclosure.

Various figures, including FIG. 1, use like reference numerals to identify similar elements. A letter after a reference numeral, such as “102a,” indicates that the text refers specifically to the element having that particular reference numeral. A reference numeral in the text without a following letter, such as “102,” refers to any or all of the elements in the figures bearing that reference numeral. Thus, user 102a refers to a specific user, while user 102 or users 102 refer to respectively a singular and plural of the users of the social networking application 101. Similarly, tags 140a1, 140a2, 140a3 of a user 102a refer to specific tags of the user 102a; tags 140a refer generally to tags of the user 102a; and tags 140 refer to tags of any or all users 102.

Users 102a, 102b, 102c, . . . , 102n interact with the application 101 using corresponding client devices 120a, 120b, 120c, . . . , 120n. Note that although a specific user 102 is illustrated to use a specific device to access the application 101, a user can use any of the devices 120 to access the application 101. In an example, the application 101 may cause to download and execute executable codes within individual client devices 120, based on which a user can use a device 120 to access the application 101, or to access online social groups 108a, . . . , 108p associated with the application 101.

The client devices 120 may have any form factor and can be any appropriate electronic devices that can be used to access the application 101, such as a personal computer (PC), a desktop computer, a laptop computer, a notebook, a tablet PC, a personal digital assistant (PDA), a mobile telephone, smart phone, and/or appropriate consumer electronic devices that can be used to access and interact with the application 101. The client devices 120 may execute an appropriate operating system, for example, a Microsoft Windows-compatible operating system (OS), Apple OS X, and/or a Linux distribution, for example. In some embodiments, the client device 120 may use a web browser as an interface to interact with the social networking system. In other embodiments, specialized application software such as native applications on a mobile device may be used as an interface to interact with the social networking system.

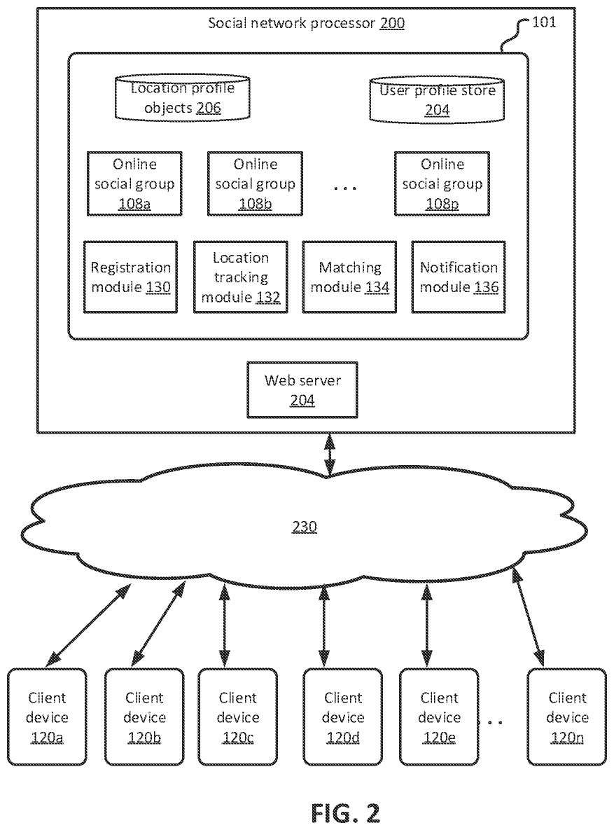

The environment 100 includes the social networking application 101 (henceforth also referred to herein as “application 101”), which may be a cloud based social networking application (e.g., hosted by a social network processor 200, discussed with respect to FIG. 2). In an example, the social networking application 101 may be for managing online social groups (also referred to simply as groups) 108a, 108b, . . . , 108p. For example, the social networking application 101 may manage one or more users 102 joining a group, one or more other users exiting another group, and so on. As will be described below, the social networking application 101 may cause users to join and/or exit groups automatically or at least semi-automatically (e.g., may at least automatically provide users option to join a group and/or to exit a group). For example, the social networking application 101 may automatically match users to respectively groups, based on one or more tags and geolocation parameters associated with the users, as will be described below.

Any appropriate type of groups 108a, 108b, . . . , 108p may be possible, such as a group in which like-minded people (e.g., sharing a similar profession, similar education level, similar neighborhood, similar school, similar interest, etc.) can participate.

In an example, the groups are based on physical location of the users. For example, a group 108 has users who are located geographically proximate to each other, e.g., within a same geographical location. The boundary of the location is implementation specific. For example, a group 108 can have users who are located within a same neighborhood or community, or a same college campus, or within a same zip code, or within a same city, indicated as location filter 152 in FIG. 1. For example, a first group can have the city of Portland, Oreg. as a corresponding location filter 152, whereas a second group have the city of Beaverton, which is a suburb of Portland, as a corresponding location filter 152. In another example, a third group can indicate Portland and all its suburbs as a corresponding location filter 152. In yet another example, a fourth group can indicate a section (e.g., a north-east section) of the city of Portland as a corresponding location filter 152. In a further example, a fifth group can indicate a neighborhood or a zip code of Portland as a corresponding location filter 152.

Thus, a group can be associated with a geographical boundary or geographical location (indicated as a corresponding location filter 152), and users located within that boundary or location can be a member of that group. The location filter 152 associated with a group can be indicated when the group is being formed, and/or may be governed by bylaws or governing principles of the group (e.g., may be changed, such as expanded or contracted, by an administrator of the group).

In an example, the application associates each user 102 with (i) one or more corresponding tags 140 and (ii) a corresponding location parameter 142. For example, a tag 140 associated with a user may be a characteristic that is associated with a profile of the user. A tag 140 generally doesn't change with time (e.g., unless the user changes it). A tag 140 defines an interest, demographic information, biographic information, personal or professional information, or other relevant type of information. The application 101 maintains user profile objects 104 representing information of individual users 102, such as tags 140 of individual users 102. The application 101 also maintains location profile objects 106 representing location parameters 142 of individual users 102.

For example, the user 102a has tags 140a1, 140a2, 140a3, and so on, and a location parameter 142a; the user 102b has tags 140b1, 140b2, 140b3, and so on, and a location parameter 142b; the user 102n has tags 140n1, 140n2, 140n3, and so on, and a location parameter 142n, although the tags and location parameters of merely the users 102a and 102n are illustrated in FIG. 1.

For example, the user 102a may have a plurality of associated tags 140a1, 140a2, 140a3, and so on, such as a first tag 140a1 indicating that the user 102a is an alumni of ABC university, a second tag 140a2 indicating that the user 102a is interested in chess, a third tag 140a3 indicating that the user 102a is interested in salsa dancing, a fourth tag 140a4 indicating that the user 102a loves movies of a particular genre, a fifth tag 140a5 indicating that the user was a member of a XYZ fraternity house while he or she was attending ABC university, a sixth tag 140a6 indicating that the user is originally from the state of Hawaii (note that while Hawaii may be the user's home state, Hawaii may not necessarily be the user's current location parameter 142a, as the user may currently be located in another state currently), and so on. The discussed example tags 140a1, 140a6 of the user 102a may be stored as the user profile objects 104 for the user 102a. Other users 102b, . . . , 102n may also have similar associated tags.

In an example, when a user 102 registers with the application 101 (e.g., the registration module 130 of the application 101), the user 102 provides information about himself or herself, based on which the application 101 (e.g., the registration module 130 of the application 101) generates and associates the tags 140 with the user 102. For example, during registration, the user 102a specifies a degree from ABC university, interests in chess, salsa dancing, and movies of the particular genre, the XYZ fraternity house while attending ABC university, and the state of Hawaii as his or her home states. Based on such information, the application 101 (e.g., the registration module 130 of the application 101) assigns the above discussed tags 140a1, 140a6 to the user 102a. Note that these six tags 140a1, 140a6 are mere examples, and the user 102a may have any other associated tags as well. Similarly, other users 102b, . . . , 102n may also be assigned corresponding tags during registration.

A user 102 may update one or more tags 140 associated with the user 102, e.g., any time after registration. For example, while during registration the user 102a indicates chess, salsa dancing, and movies of the particular genre as his or her interests, the user 102a can update his or her areas of interests later on. Similarly, upon earning a new degree from another university, the user 102a can supply information associated with the new university to the application 101, based on which the application 101 can generate new tags for the user 102a.

As previously discussed, in addition to the tags, a user 102 may also be associated with a location parameter 142a, which is indicative of an approximate current location of the user 102. In an example, the application 101 (e.g., a location tracking module 132 of the application 101) can track the location of the client device 120a of the user 102a (e.g., based on codes associated with the application 101 downloaded and being executed from the client device 120a), and can accordingly update the location parameter of the user 102a. In another example, the user 102a can manually update his or her current location, e.g., by interacting with the application 101.

In an example, various rules may be associated with updating the location parameter 142 of a user. For example, assume that the user 102a lives in the city of Portland, and works in the city of Beaverton (which is a suburb of Portland). The location parameter 142 of the user 102a may indicate one or both of Portland and Beaverton. In another example, because Portland and Beaverton are in close geographical proximity, a location parameter 142 indicating Portland may also cover all suburbs of Portland, including Beaverton. In yet another example, the location parameter 142 may be updated on a real time basis, e.g., based on a current location of the user 102a. For example, during work while the user 102a is in Beaverton, the location parameter 142 may indicate Beaverton; and while the user 102a is in Portland after or before work, the location parameter 142 may indicate Portland.

In another example, the location parameter 142 can be updated based on a user being in a location for at least a threshold period of time. For example, assume that the user 102a is going on a road trip from Portland to Los Angeles by car, and stays in Los Angeles for 7 days. During the trip, the user 102a passes through San Francisco. In an example, while the user 102a passes through San Francisco and assuming that the threshold period of time is relatively less (such as an hour), for the time the user 102a is in San Francisco, the location parameter 142a may indicate San Francisco. In another example, assuming that the threshold period of time is relatively more (such as a day), if the user 102a doesn't stay in San Francisco for more than a day, the location parameter 142a is not updated to San Francisco. As will be discussed, the threshold period of time may be specific to a group (i.e., each group may set its own threshold period of time), or may be set by the application 101.

Once the user reaches in Los Angeles and stays in Los Angeles for at least the threshold period of time, the location parameter 142a may be updated to Los Angeles. In another example, the user 102a may know that he is visiting Los Angeles for merely 7 days and may not want to join any Los Angeles based groups. In that case, the user 102a may choose to increase the threshold period of time to 10 days for example, in which case the location parameter 142a may not be updated to Los Angeles. In another example, the user 102a may choose to manually indicate to the application 101 about not updating the location parameter 142a while the user 102a travels, in which case the location parameter 142a may not be updated to Los Angeles.

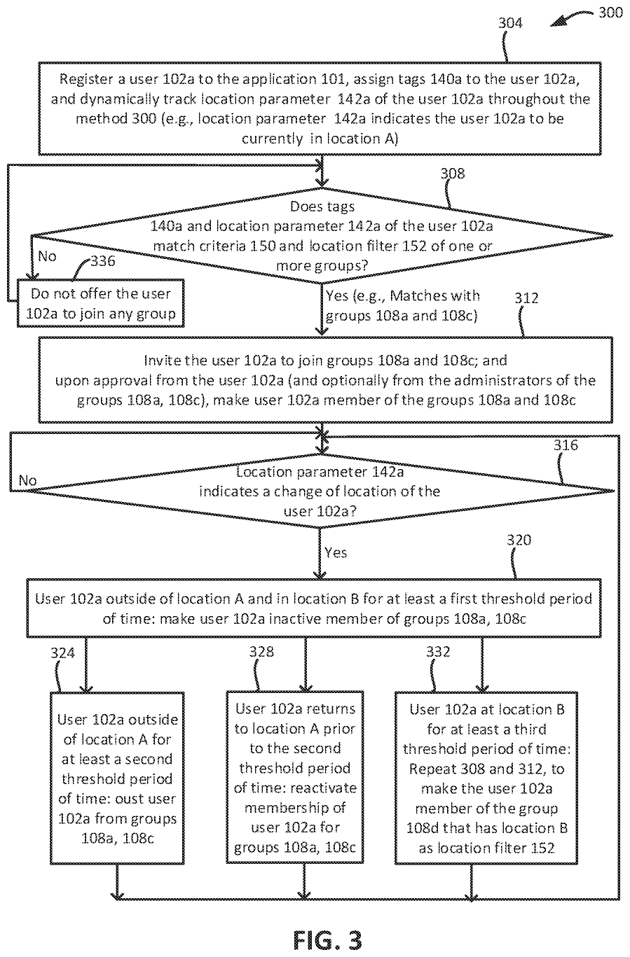

Furthermore, once the user 102a is out of Portland during the trip, the location parameter 142a may, after another threshold period of time, cease to indicate Portland being a current location of the user 102a, where the other threshold period of time may be user configurable, or may be configured by the application 101, or may be configured by individual groups 108 to which the user 102a is a member. In one example, once the user is outside Portland for at least the threshold period of time (which may be one day, two days, a week, or a month, for example), the location parameter 142a may cease to indicate Portland being the current location of the user 102a, and the user 102a may be automatically ousted or expelled (e.g., by the application 101) from any Portland based groups of the application 101, as will be discussed in further detail with respect to FIG. 3.

In another example, once the user 102a is outside Portland for a first threshold period of time, the application 101 may flag the user 102a as being an inactive or non-present (e.g., absent) member of a Portland based group. Once the user 102a is outside Portland for a second threshold period of time, the application 101 may expel the user 102a from the Portland based group, where the second threshold period of time is greater than the first threshold period of time, as will be discussed in further detail with respect to FIG. 3.

In an example, each online social group 108 has one or more criteria 150 and a location filter 152. For example, social group 108a has criteria 150a1, 150a2, 150a3, and so on, and a location filter 152a; social group 108b has criteria 150b1, 150b2, 150b3, and so on, and a location filter 152b; social group 108p has criteria 150p1, 150p2, 150p3, and so on, and a location filter 152p, and so on, where the criteria and the location filters of merely the social groups 108a and 108p are illustrated in FIG. 1.

In an example, criteria 150 of the group 108 indicates criteria for joining the group 108, and the location filter 152 indicates a geographical location. In an example, the criteria 150 for joining a group 108 may be interest criteria, e.g., indicating interest areas of a person to join the group. Note that the “interest” in the term “interest criteria” is intended to cover any areas of interest, such as hobbies or interest in an interest area, being an alumni or a student of an educational institution, having an education degree or a professional degree or a diploma, or previously belonging to a geographical location, and/or other social, demographic, biographic, personal or professional information, and/or other relevant type of information about the user, for example.

As discussed herein, a user 102 having a location parameter 142 matching the location filter 152 of a group 108 and having one or more tags 140 matching the criteria 150 of the specific group 108 can join that group 108.

For example, assume that a criterion 150a1 of the group 108a indicates interest in chess, another criterion 150a2 of the group 108a indicates people who are from Hawaii, and the location filter 152a of the group 108a indicates current location of Portland. Thus, the founders and/or members of the group 108a may be a native Hawaiians and plays chess, and currently lives in Portland, Oreg., and they want to meet like-minded people (i.e., native Hawaiian having interest in chess) from the same geographical location of Portland, Oreg. Note the stress in the same geographical location of Portland, Oreg., e.g., because members of the group 108a may prefer to meet in-person occasionally or periodically, e.g., to play chess and/or to socialize.

Note that as discussed above, a tag 140a2 of the user 102a indicates that the user 102a is interested in chess, and a tag 140a6 of the user 102a indicates that the user is originally from the state of Hawaii. Also assume that the location parameter 142a of the user 102a indicates that the user 102a lives in Portland. Accordingly, the tags 140a and location parameter 142a of the user 102a match the criteria 150a and location filter 152a of the group 108a. For example, the matching module 134 of the application 101 may match the user 102a with the group 108a.

Accordingly, in an example, the matching module 134 may automatically invite the user 102a (e.g., without the user 102a needing to actively perform a search) to join the group 108a, which the user 102a may choose to accept (e.g., the user 102a joins the group 108a) or reject (e.g., the user 102a chooses to not join the group 108a).

In another example, the matching module 134 may automatically join the user 102a (e.g., without the user 102a needing to actively perform a search and join) to the group 108a. That is, once the tags 140a and the location parameter 142a indicate a match with the criteria 150a and the location filter 152a, the matching module 134 assumes that the user 102a is interested in joining the group 108a, and automatically makes the user 102a a member of the group 108a.

In yet another example, based on the above discussed matching, the matching module 134 may automatically join the user 102a (e.g., without the user 102a needing to actively perform a search and join) to the group 108a, e.g., by making the user 102a a provisional or semi-permanent (or temporary) member of the group 108a. Then the user 102a and/or the current administrator of the group 108a can turn the provisional or semi-permanent membership into a permanent or full or regular membership of the group 108a, e.g., in case the user 102a likes being a member of the group 108a and/or if the current administrator of the group 108a likes the user 102a being a member of the group 108a. In an example, the provisional members of a group may have less privileges than a regular member (e.g., may not have power to vote or to organize events, for example).

On the other hand, the group 108b may have a criterion 150b1 indicating an interest in kayaking. As none of the tags 140a of the user 102a may have kayaking as an interest, the user 102a may not be offered to join the group 108b, and cannot join the group 108b.

In an example, the location criteria of the user 102a is dynamically updated, based on the current location of the user 102a, as discussed herein above. For example, if the user 102a is absent from Portland for at least a first threshold amount of time (e.g., the user 102a is visiting Los Angeles for 7 days), the user 102a can be made an inactive member of the group 108a, e.g., to indicate that the user 102a is not currently present in Portland. In an example, if the user 102a is absent from Portland for at least a second threshold amount of time (where the second threshold amount of time is greater than the first threshold amount of time), the user 102a can be ousted from expelled automatically from the group 108a, as the user 102a is no longer considered a resident of Portland.

The application 101 is illustrated to include various modules, such as registration module 130, location tracking module 132, matching module 134, notification module 136, as discussed herein. Note that in some examples, some of the modules of the application 101 may be combined, and/or some of the modules may be split in two or more modules.

FIG. 2 schematically illustrates a system architecture of the social networking application 101, for facilitating automatic filtration of users 102a, 102b, . . . , 102n for joining and/or exiting various online social groups 108a, . . . , 108p, e.g., based on one or more tags associated with individual users 102 and based on a geolocation parameter that is updated dynamically for individual users 102, in accordance with an embodiment of the present disclosure.

In an example, a social network processor 200 executes the social network application 101. The social networking application 101 stores user profile objects 104 in a user profile store 204. The information stored in user profile store 204 includes various relevant information about the users 102 of the social networking system 101, such as the tags 140.

The social networking application 101 stores location profile objects 104 in a location profile store 206. The information stored in location profile store 206 includes various relevant information about locations of the users 102, such as the location parameters 142.

In one embodiment, the web server 204 links the social networking application 101 via one or more networks 230 to one or more client devices 120. In an example, the web server 204 serves web pages, as well as other related content, such as Flash, XML, or other appropriate web related content. In an example, the web server 204 enables communication between the social networking application 101 and the various client devices 120. These messages may be appropriate messages used by the social group, as well as invitation for candidate registration, invitation to vote, receiving votes cast by the users, as well as message notifying past, current, and/or past holders of various positions regarding changes in positions and/or associated changes in administrative privileges.

The network 230 may be an appropriate network, such as the Internet. In an example, the network 230 facilitates communications between the client device 120 and the social networking application 101. The network 230 may be use any standard or proprietary communication protocols for communication between the client devices 120 and the social networking application 101. Examples of such communication protocols may include, but is not limited to, worldwide interoperability for microwave access (WiMAX), Ethernet, 802.11, digital subscriber line (DSL), 3G, asynchronous transfer mode (ATM), InfiniBand, PCI Express Advanced Switching, etc. Similarly, the networking protocols used on the network 210 may include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), Long-Term Evolution (LTE), 5G, and/or other appropriate communication protocols. In an example, data exchanged over network 230 may be represented using technologies and/or formats including the hypertext markup language (HTML), the extensible markup language (XML), and/or other appropriate technologies and/or formats.

FIG. 3 illustrates a method 300 for facilitating automatic filtration of users 102a, 102b, . . . , 102n for joining and/or exiting various online social groups 108a, . . . , 108p, e.g., based on one or more tags 140 associated with individual users 102 and based on a geolocation parameter 142 that is updated dynamically for individual users 102, in accordance with an embodiment of the present disclosure.

Note that the method 300 of FIG. 3 is directed towards a specific user, such as the user 102a joining and/or exiting various groups, and the teachings of the method 300 of FIG. 3 may be applied similarly for any other users registered with the application 101.

Referring to FIG. 3, at 304 of method 300, the application 101 (such as the registration module 130) registers a user 102a to the application 101. During the registration process, the application 101 collects various information about the user 102a, such as one or more of interests or hobbies of the user, educational institutions that the user attended or is current attending, education degrees and/or professional degrees or diplomas of the user, home town of the users, demographic information, biographic information, personal or professional information, and/or other relevant type of information about the user, for example. In an example, based on such collected information, the application 101 assign one or more tags 140a to the user 102a, where the tags 140a are indicative of the collected information. Merely as examples, a tag 140a1 indicates that the user 102a is an alumni of ABC university, a tag 140a2 indicates that the user 102a is interested in chess, a tag 140a3 indicates that the user 102a is interested in salsa dancing, a tag 140a4 indicates that the user 102a loves movies of a particular genre, a tag 140a5 indicates that the user was a member of a XYZ fraternity house while he or she was attending ABC university, a tag 140a6 indicates that the user is originally from the state of Hawaii, and so on. As discussed above, the tags 140a may be stored as user profile objects 104, which may be stored in the user profile store 204.

In an example, the application 101 also may dynamically tracks and updates a location parameter 142a of the user 102a. For example, while the application 101 interacts with the user 102a, the application downloads and executes executable codes in the corresponding client device 120a of the user 102a. The application 101 may seek relevant permission from the user 102a, to allow the executable codes within the client device 120a to track the location of the user 102a in real or near-real time, and transmit such location information to the application 101, e.g., to the location tracking module 132 of the application 101. The location tracking module 132 then updates the location parameter 142a of the user 102a, based on such real time or near-real time location information of the client device 120a of the user 102a. In the example of FIG. 3, the user 102a is assumed to be in an example location A, which may be a neighborhood, a city, a college campus, and/or a zip code. As discussed above, the location parameter 142 may be stored as location profile objects 106, which may be stored in the location profile store 206. In an example, the location parameter 142a is assumed to be updated throughout the method 300, e.g., in case the user 102a travels outside location A.

The method 300 then proceeds from 304 to 308, where the application 101 (e.g., the matching module 134) determines if the tags 140a and location parameter 142a of the user 102a match criteria 150 and location filter 152 of one or more groups 108a, . . . , 108p. For example, group 108a has criteria 150a1, 150a2, 150a3, and so on, and the criteria 150a1, 150a2, 150a3 has to have corresponding matching tags 140a1, 140a2, 140a3, and so on, as well as the location filter 152a has to match with the location parameter 142a, for the group 108a to be a match for the user 102a.

If “No” at 308, no group matches the location and tags of the user 102a, and accordingly, the method 300 proceeds from 308 to 336, where the application 101 does not offer the user 102a to join any group. The method 300 then loops back to 308. Note that in case the location of the user 102a changes and/or if the user 102a updates one or more information associated with the user 102a (e.g., if the tags 140s of the user 102a are updated), there may be a future match between the user 102a and one or more groups.

If “Yes” at 308, the application 101 finds one or more groups having criteria 150 and location filter 152 respectively matching the tags 142a and the location parameter 142a of the user 102a. Assume, merely as an example, that there is a matching between groups 108a, 108c and the user 102a. The method 300 then proceeds from 308 to 312.

At 312, the application 101 invites the user 102a to join the matching groups 108a and 108c. For example, through the notification module 136, the application 101 may notify the user 102a that the groups 108a and 108c match the interest and location of the user 102, and the user 102 may join the group. The user 102a may accept the request, and upon approval from the user 102a (and optionally from the administrators of the groups 108a, 108c), the application 101 may make the user 102a a member of the groups 108a and 108c.

However, in another example, based on the above discussed matching of groups 108a and 108c, the application 101 may automatically join the user 102a to the groups 108a, 108c, e.g., by making the user 102a a provisional or semi-permanent (or temporary) member of the groups. Then the user 102a and/or the current administrator of these groups can turn the provisional or semi-permanent membership into a regular or full membership of the groups, e.g., in case the user 102a likes being a member of the groups and/or if the current administrators of the groups 108a, 108c like the user 102a being a member of these groups.

The method 300 then proceeds from 312 to 316. Note that as described above, in an example, the location parameter 142a is updated throughout the method 300 (e.g., in real time or near-real time basis), e.g., in case the user 102a travels outside location A. For example, at 316, the application 101 (e.g., the location tracking module 132) determines if the location parameter 142a indicates a change of a location of the user 102a, in case the user 102a moves out of location A. If “No” at 316 (e.g., no change in location of the user 102a, and the user 102a is in location A), then the method 300 loops back to 316, and the application 101 keeps on checking any possible change in location of the user 102a.

If “Yes” at 316 (e.g., the location tracking module 132 detects a change in location of the user 102a), then the method 300 proceeds from 316 to 320. For example, assume that the user 102a moves from location A to a new location B. At 320, if the user 102a is outside of location A and in location B for at least a first threshold period of time, the application 101 makes the user 102a inactive or non-participating members of groups 108a, 108c. The first threshold period of time may be, for example, 2 days, 3 days, 5 days, a week, 10 days, 2 weeks, 3 weeks, a month, or the like. While the user 102a is an inactive of a group, the user 102a cannot participate in in-person events of the group. The first threshold period of time ensures that the user 102a is not made inactive if the user 102a is outside location A on a temporary basis or for a short period of time.

In another example, the user 102a may be provided with an option to be inactive (or altogether quit) in an online social group (e.g., via the notification module 136), based on the user 102a being outside location A for the first threshold period of time of the online social group. Based on the response of the user 102a, the user 102a may be made inactive or may be expelled from the group.

In an example, the duration of the first threshold period of time may be set by governing principles of individual groups, and/or may be set by the application 101. For example, a first group collaborating on computer research may meet in-person once a quarter, and an absence of a member from the location of the group for a few months may not be a deterrent factor for the member—accordingly, the first threshold period of time for the first group may be set to 3 months or 6 months, for example. On the other hand, a second group may comprise neighbors meeting every day in person for evening walks. Accordingly, for the second group, the first threshold period of time may be relatively less, e.g., 4 days, or a week, or 2 weeks, for example.

From 320, the method 300 may branch out to one or more of processes 324, 328, and/or 332. For example, at 324, it is assumed that the user 102a is outside of location A for at least a second threshold period of time, where the second threshold period of time is greater than the first threshold period of time. In such a case, the application 101 ousts or expels the user 102a from one or both the groups 108a and/or 108c.

In another example, the user 102a may be provided with an option to be expelled from an online social group (e.g., via the notification module 136), based on the user 102a being outside location A for the second threshold period of time of the online social group. Based on the response of the user 102a, the user 102a may be expelled from the group.

Again, the duration of the second threshold period of time may be set by governing principles of individual groups, and/or may be set by the application 101. For example, continuing with the above discussed example of the first group collaborating on computer research, the second threshold period of time for the first group may be set to six months or a year, for example, as the group may meet in person 2-4 times a year, and an absence of the user 102a from such infrequent meetings may not be sufficient reason to outs the user 102a from the group. On the other hand, for the second group comprising neighbors meeting every day in person for evening walks, the second threshold period of time may be relatively less, e.g., 15 days, 1 month, 2 months, 3 months, or 6 months, for example.

The method 300 may also branch out from 320 to 328. For example, only any one of processes 324 or 328 may be executed, based on how long the user 102a was outside the location A. For example, at 328, the user 102a returns to location A prior to the second threshold period of time, in which case the membership of user 102a may be reactivated for the groups 108a, 108c.

As discussed above, the second threshold period of time may be different for different groups. In the above discussed example, the first and second threshold period of times for the first group may be 3 months and 1 year, respectively; and the first and second threshold period of times for the second group may be 1 month and 2 months, respectively. Assume, for example, that the user 102a was outside location A for 4 months. Accordingly, after 1 month the user 102a may be made inactive for the second group, and after 2 months the user 102a may be expelled from the second group. After 3 months, the user 102a may be made inactive for the first group. Once the user 102a returns to location A after 4 months, the membership of the user 102a may be automatically reactivated for the first group (e.g., the user 102a doesn't need to rejoin the first group). However, as the user 102a was expelled from the second group after 3 months, the user 102a now (e.g., upon returning after 4 months) have to rejoin the second group, e.g., as discussed with respect to process 312 of method 300.

In another example, the processes 320 and 324 may be combined in a single process, where in response to the user 102a being outside location A for a fourth threshold period of time, the user 102a is simply expelled from the group. Note that in this example, there is no first and second threshold period of times, and there is just the fourth threshold period of time. Thus, in this example, there is no intermediate step of making the user inactive, and then expelling the user from the group. Rather, if the user is outside location A for at least the fourth threshold period of time, the user 102a is directly expelled from the group. Again, as discussed above, each group can set its own fourth threshold period of time, and is based on governing principles of the group.

In an example, the above discussed first and second groups may choose to initially make a member inactive (see 320) and then eventually expel the member (see 324), based on a duration of absence of the member from the location A. In an example, a third group may, on the other hand, choose to directly expel a member, e.g., based on the member being absent from location A for the above discussed fourth threshold period of time. Thus, while some groups can choose to execute processes 320 and 324 (i.e., make inactive, and then expel), some other groups can choose to directly expel a member. In an example, whether a group decides to initially make inactive and then expel a member, or decides to directly expel the member, may be based on governing principles of the group (e.g., which may be changed by administrator of the group through group settings). Thus, while a group may decide on the former approach, another group may decide on the later approach. The application 101 may provide individual groups a freedom to choose policies affecting a manner in which members are to join the group and be inactivated/expelled form the group.

In an example, the user 102a may be provided with an option to be made inactive or expelled from an online social group (e.g., via the notification module 136), based on the user 102a being outside location A for the first, second, and/or fourth threshold period of time of the online social group. Based on the response of the user 102a, the user 102a may be made inactive or expelled from the group.

The method 300 may also branch out from 320 to 332. Note that process 332 may be performed at least in part in parallel with, and independent from, processes 324 and 328. At 332, the user 102a is assumed to be at location B for at least a third threshold period of time, where the third threshold period of time may be same as, or different from, any of the above discussed first and second threshold period of times. Again, the third threshold period of time may be set by the application, and/or may be set differently by specific groups. Thus, once the user is at location B for at least some amount of time, the user 102a may be invited to join groups local to location B. Accordingly, processes 308 and 312 may be repeated, e.g., to make the user 102a a member of an example group 108d that has location B as location filter 152 (e.g., assuming that the tags 140a of user 102a match the criteria 150d of group 108d). Then the method 300 may loop back to 316, where the application checks to see if there has been any further movement of the user 102a.

Note that the third threshold period of time ensures that the user 102a is not given an option to join a group of a location, when the user 102a is merely passing by through the location. For example, assume the user is driving from location A to location B, via location C. The user may take a brief lunch break at location C, and unless the user 102a spends at least the third threshold period of time in location C (e.g., at least a few hours, or a few days, or a few weeks, or a month, for example), the user 102 may not be invited to join the groups affiliated with location C.

The features and advantages described in the specification are not all inclusive and, in particular, many additional features and advantages will be apparent to someone skilled in the art in view of the drawings, specification, and claims. Some portions of this description describe the embodiments of the invention in terms of algorithms and symbolic representations of operations on information. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method comprising:
registering a plurality of users for an application, the application associated with a plurality of online social groups, each online social group having one or more corresponding criteria and a location based filter for users to join the online social group;
maintaining one or more corresponding tags of each user of the plurality of users, and maintaining and tracking a location parameter of each user of the plurality of users;
matching a first user of the plurality of users to a first online social group of the plurality of online social groups, based on one or more corresponding tags and the location parameter of the first user satisfying the one or more corresponding criteria and the location based filter, respectively, of the first online social group; and
based on matching the first user to the first online social group, admitting the first user to the first online social group.

2. The method of claim 1, wherein admitting the first user to the first online social group comprises:
based on matching the first user to the first online social group, inviting the first user to join the first online social group; and
in response to the user accepting the invitation, admitting the first user to the first online social group.

3. The method of claim 1, wherein admitting the first user to the first online social group comprises:
based on matching the first user to the first online social group, automatically admitting the first user as a provisional member of the first online social group; and
subsequent to automatically admitting the first user as the provisional member of the first online social group and in response to receiving a response from the first user and/or an administrator of the first online social group, admitting the first user as a regular member of the first online social group.

4. The method of claim 1, further comprising:
based on tracking the location parameter of the first user, determining that the location parameter of the first user is not matching the location based filter of the first online social group for at least a threshold period of time; and
based on determining that the location parameter of the first user is not matching the location based filter for at least the threshold period of time, marking the first user an inactive user of the first online social group.

5. The method of claim 4, wherein while the first user is marked as the inactive user, the first user cannot be scheduled to participate in an in-person event of the first online social group.

6. The method of claim 4, where the threshold period of time is a first threshold period of time, and wherein the method further comprises:
based on tracking the location parameter of the first user, determining that the location parameter of the first user is not matching the location based filter of the first online social group for at least a second threshold period of time; and
based on determining that the location parameter of the first user is not matching the location based filter for at least the second threshold period of time, expelling the first user from the first online social group.

7. The method of claim 1, further comprising:
based on tracking the location parameter of the first user, determining that the location parameter of the first user is not matching the location based filter of the first online social group for at least a threshold period of time; and
based on determining that the location parameter of the first user is not matching the location based filter of the first online social group for at least the threshold period of time, expelling the first user from the first online social group.

8. The method of claim 1, further comprising:
based on tracking the location parameter of the first user, determining that the location parameter of the first user is not matching the location based filter of the first online social group for at least a threshold period of time; and
based on determining that the location parameter of the first user is not matching the location based filter of the first online social group for at least the threshold period of time, providing the first user an option to quit the first online social group.

9. The method of claim 8, further comprising:
based on a response received from the first user to quit the first online social group, ousting the first user from the first online social group.

10. The method of claim 1, wherein:
the first online social group has a policy to oust a user, if the location parameter of the user doesn't match with the location based filter of the first online social group for a first threshold period of time; and
the second online social group has a policy to oust a user, if the location parameter of the user doesn't match with the location based filter of the second online social group for a second threshold period of time,
wherein the first and second threshold period of times are different.

11. The method of claim 1, further comprising:
based on tracking the location parameter of the first user, determining that the location parameter of the first user is not matching the location based filter of the first online social group and is matching a location based filter of a second online social group for at least a threshold period of time;
further determining that the one or more corresponding tags of the first user satisfy one or more corresponding criteria of the second online social group; and
admitting the first user to the second online social group, subsequent to at least the threshold period of time.

12. The method of claim 1, wherein the one or more tags of the first user are indicative of one or more of interests of the first user, educational institutions that the first user attended or is current attending, education degree and/or professional degree or diploma of the first user, home town of the first users, demographic information, biographic information, personal or professional information, and/or other relevant type of information about the first user.

13. A non-transitory, computer-readable storage media comprising instructions operable, when executed by one or more computing systems of an online social network, to:
register a plurality of users for an application that is associated with a plurality of social groups, each social group having corresponding joining criteria and a corresponding location criterion;
determine that a first user of the plurality of users satisfy the joining criteria and the location criterion of a first social group of the plurality of social groups;
admit the first user to the first social group, and tracking a location of the first user;
subsequent to admitting the first user to the first social group and based on tracking the location of the first user, determine that the first user no longer satisfies the location criterion of the first social group for at least a threshold period of time; and
based on determining that the first user no longer satisfies the location criterion of the first social group for at least a threshold period of time, cause to expel the first user from the first social group.

14. The non-transitory, computer-readable storage media of claim 13, wherein the threshold period of time is a combination of a first threshold period of time and a second threshold period of time, and wherein expelling the first user from the first social group comprises:
based on determining that the first user no longer satisfies the location criterion of the first social group for at least the first threshold period of time, causing to inactivate the first user in the first social group; and
based on determining that the first user no longer satisfies the location criterion of the first social group for at least the second threshold period of time, causing to expel the first user from the first social group.

15. The non-transitory, computer-readable storage media of claim 13, wherein the threshold period of time is a first threshold period of time, and wherein the instructions are further operable to:
determine that the first user also satisfy the joining criteria and the location criterion of a second social group;
admitting the first user to the second social group, along with admitting the first user to the first social group;
subsequent to admitting the first user to the first and second social groups and based on tracking the location of the first user, determining that the first user no longer satisfies the location criterion of the second social group for at least a second threshold period of time; and
based on determining that the first user no longer satisfies the location criterion of the second social group for at least a second threshold period of time, causing to expel the first user from the second social group,
wherein the first threshold period of time for expelling the first user from the first social group is different from the second threshold period of time for expelling the first user from the second social group.

16. The non-transitory, computer-readable storage media of claim 13, to cause to expel the first user from the first social group, the instructions are further operable to:
based on determining that the first user no longer satisfies the location criterion of the first social group for at least a threshold period of time, cause to provide an option to the first user to quit the first social group; and
based on a response received from the first user to quit the first social group, cause to expel the first user from the first social group.

17. The non-transitory, computer-readable storage media of claim 13, wherein the joining criteria of the first social group includes one or more of having interest in an interest area, being an alumni or a student of an educational institution, having an education degree or a professional degree or a diploma, or previously belonging to a geographical location.

18. The non-transitory, computer-readable storage media of claim 13, wherein the location criterion of the first social group necessities that members of the first social group live within one or more of a neighborhood, a city, a zip code, a college campus, or a geographical area.

19. A computer system for executing operations in a social network application, the computer system comprises a social network processor implementing the social network application, the social network processor configured to implement the social networking application to:
register a user, wherein the social networking application is associated with a plurality of online social groups, each social group having one or more corresponding interest criteria and a location criterion for users to join the online social group;
automatically match the user to at least a first social group and a second online social group, based on the user satisfying the interest criteria and the location criterion of each of the first social group and the second online social group; and
admit the user to the first online social group and the second online social group.

20. The computer system of claim 18, wherein the social network processor is further configured to implement the social networking application to:
determine that the user fails satisfy the location criterion of the first social group for at least a first threshold period of time and the user fails satisfy the location criterion of the second social group for at least a second threshold period of time; and
expel the user from the first online social group after the first threshold period of time, and expel the user from the second online social group after the second threshold period of time, the first threshold period of time being different from the second threshold period of time.
